(19) United States
(12) Patent Application Publication
(10) Pub. No.: US 2015/0040711 A1
(43) Pub. Date: Feb. 12, 2015

(54) PARALLEL MICRO-ROBOT WITH 5-DEGREES-OF-FREEDOM

(71) Applicants: KOH YOUNG TECHNOLOGY INC., Seoul (KR); KOREA UNIVERSITY RESEARCH AND BUSINESS FOUNDATION, Seoul (KR)

(72) Inventors: Whee-Kuk Kim, Seoul (KR); Sung-Mok Kim, Seoul (KR); Jae-Heon Chung, Gwangmyeong-si (KR); Byung-Ju Yi, Bucheon-si (KR)

(73) Assignee: KOH YOUNG TECHNOLOGY INC., Seoul (KR)

(21) Appl. No.: 14/372,298

(22) PCT Filed: Apr. 24, 2013
(86) PCT No.: PCT/KR2013/003483

§ 371 Date: Jul. 15, 2014

(30) Foreign Application Priority Data
Apr. 26, 2012 (KR) 10-2012-0044043
Sep. 17, 2012 (KR) 10-2012-0102802

(51) Int. Cl. B25J 7/00; B25J 9/00

(52) U.S. Cl. CPC B25J 7/00; B25J 9/0072; B25J 9/0063
USPC 74/490.01

(57) ABSTRACT

A parallel micro-robot with five degrees of freedom that is capable of manufacturing in compact size as well as capable of controlling more precisely compared with conventional parallel robot is disclosed. The parallel micro-robot with five degrees of freedom is capable of controlling an angle of the operating plate very precisely around two shafts rotating connection means which couples operating plate and up/down height adjusting actuator using a first and second angle adjusting actuator, and therefore, high accuracy is secured.

### TECHNICAL FIELD

Exemplary embodiments of the present invention relate to a micro-robot providing parallel structure and 5 degrees of freedom. More particularly, exemplary embodiments of the present invention relate to a micro-robot providing parallel structure with 5 degrees of freedom used in stereotactic surgery.

### BACKGROUND ART

In general, conventionally, serial structured robot is used to control a position and an orientation on a three-dimensional during an operation using robot. However, in recent years, various types of robots with parallel structure have been developed and are used alternatively to the serial structure.

The advantage of the parallel surgical robot is that it is possible to increase a speed and an acceleration of a machine by reducing inertial mass of moving part compared to serial surgery robot, to increase rigidity of machine by coupling a base plate and an operating plate with plurality of actuators in which the actuators receive tensile and compression forces instead of bending force, and to improve accuracy by applying error of each actuator in average to operating plate compared with the serial structure surgery robot while error is accumulated in serial structure.

However, when a degree of freedom is increased, number of actuators corresponding to the degree of freedom that has been increased is needed to be installed on base plate. Therefore, manufacturing cost is increased as well as spatial restriction on operating and installing may be occurred when the surgical robot is designed with more than 5 degrees of freedom and the surgical robot becomes large size.

And, conventional parallel surgical robot has many restrictions on driving mechanically as an orientation motion and a translation motion is operated organically.

### DISCLOSURE

### Technical Problem

Therefore, the technical problem of the present invention is to provide a surgical robot with parallel structure and 5 degrees of freedom with compact size compared with conventional parallel surgical robot as well as capable of controlling more precisely.

### Technical Solution

According to an embodiment of the present invention, a surgical robot with parallel structure and 5 degrees of freedom includes a first slide moving unit installed on a base plate, a second slide moving unit installed on the first slide moving unit and moves in a different direction from the first slide moving unit, an up/down moving actuator fixed and installed on the second slide moving unit, a first angle adjusting actuator arranged and positioned on a direction which the first slide moving unit moves and coupled such that the bottom portion of the first angle adjusting unit is rotatably coupled to the base plate, a second angle adjusting actuator arranged and positioned on a direction which the second slide moving moves and coupled such that the bottom portion of the second angle adjusting unit is rotatably coupled to the base plate, and an operating plate in which a center portion of the operating plate is rotatably coupled to up/down moving actuator and both sides of an end portion of the operating plate are rotatably coupled to the first and second angle adjusting actuators.

In one embodiment, the second slide moving unit may be installed on the first slide moving unit in a way that it moves to a vertical direction to the first slide moving unit.

In one embodiment, the first and second angle adjusting actuators may be arranged perpendicular to the up/down moving actuator.

In one embodiment, the up/down height adjusting actuator may be coupled to a center portion of the operating plate using a two rotation shafts connection means.

Herein, it is preferable to couple the two shafts rotating connection means to the up/down height adjusting actuator in a way that two rotation shafts are arranged parallel to the movement directions of the first and second slide moving units, respectively.

Also, the first and second angle adjusting actuators may be coupled to the base plate using two shafts rotating connection means.

Herein, it is preferable to couple the first and second angle adjusting actuators and the base plate in a way that two shafts rotating connection means is arranged parallel to the movement directions of the first and second slide moving units, respectively.

In one embodiment, the two shafts rotating connection means may be a universal joint.

In one embodiment, the first and second angle adjusting actuators of surgical robot with parallel structure and 5 degrees of freedom is characterized in that it is coupled to the operating plate using omnidirectional rotating means.

Herein, the omnidirectional means may be a ball joint.

In one embodiment, the first and second slide moving units may be LM guide.

Meanwhile, the two shafts rotating connection means which couples the up/down height adjusting actuator and the operating plate may include a fixing plate installed on the up/down moving actuator and is inserted into a hole formed on the operating plate, a pair of first rotation shafts arranged parallel to the movement direction of the first moving unit or first slide moving units and installed on the fixing plate and are positioned on a same line to each other, a rotating plate having a through hole and rotatably coupled to the pair of first rotation shafts, and a pair of second rotation shafts arranged parallel to the movement direction of the second moving unit or second slide moving unit, rotatably coupling the rotating plate to the operating plate and disposed to be positioned on a same line to each other.

Also, parallel surgical robot with 5 degrees of freedom according to the present invention further includes a roll motion preventing unit fixed and installed on the second slide moving unit to be coupled to the up/down moving actuator.

In an embodiment, the roll motion preventing unit includes a supporting member fixed and installed on the second slide moving unit, at least one guide member slidingly coupled to the supporting member, and a connecting block fixed and installed on the up/down moving actuator and installed on the guide member.

### Advantageous Effects

Thus, according to an embodiment of the present invention, a micro-robot with parallel structure and 5 degrees of freedom may obtain high accuracy by adjusting precisely an angle of the operating plate using two shafts rotating connection means as its center, wherein the with two shafts rotating connection means couples an up/down height adjusting actuator and a base plate using a first and second angle adjusting actuators.

Also, there is an effect to minimize a surgical space and an installation restrictions by manufacturing in lightweight structure of small-scale as it is possible to reduce innovatively number of actuators to be installed to control an angle of operating plate compared with conventional parallel micro-robot by forming operating plate with only the first and second angle adjusting actuators to control an angle.

Additionally, it is possible to control more precisely since mechanical properties are improved by adjusting position of the operating plate using the first and second slide moving units and the up/down moving actuator, and an orientation motion and a translation motion are driven separately as direction of the operating plate is adjusted by the first and second angle adjusting actuators.

Also, it is effective to control more precisely since a gap within two shafts rotating connecting means which couples an up/down moving actuator and an operating plate is not generated.

Also, it is effective to control furthermore precisely since rolling effect of up/down moving actuator's load is prevented by supporting the load through roll motion preventing unit connected to operating plate.

### DESCRIPTION OF DRAWINGS

FIG. 1 is a perspective view of a parallel micro-robot with 5 degrees of freedom according to a first embodiment of the present invention;

FIG. 2 is another perspective view of a parallel micro-robot with 5 degrees of freedom according to a first embodiment of the present invention;

FIG. 3 is a micro-robot according to a first embodiment of the present invention installed on a macro-robot; and

FIG. 4 is a perspective view of a parallel micro-robot with 5 degrees of freedom according to a second embodiment of the present invention.

### MODE FOR INVENTION

The present invention is described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that, although the terms first, second, third etc. may be used herein to describe various elements, components, regions, layers and/or sections, these elements, components, and/or sections should not be limited by these terms. These terms are only used to distinguish one element, component, region, layer or section from another region, layer or section. Thus, a first element, component, or section discussed below could be termed a second element, component, or section without departing from the teachings of the present invention.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

For convenience, same numerals are used for identical or similar elements of an apparatus of cutting a tempered substrate and the conventional one.

Hereinafter, with reference to the drawings, preferred embodiments of the present invention will be described in detail.

### First Embodiment

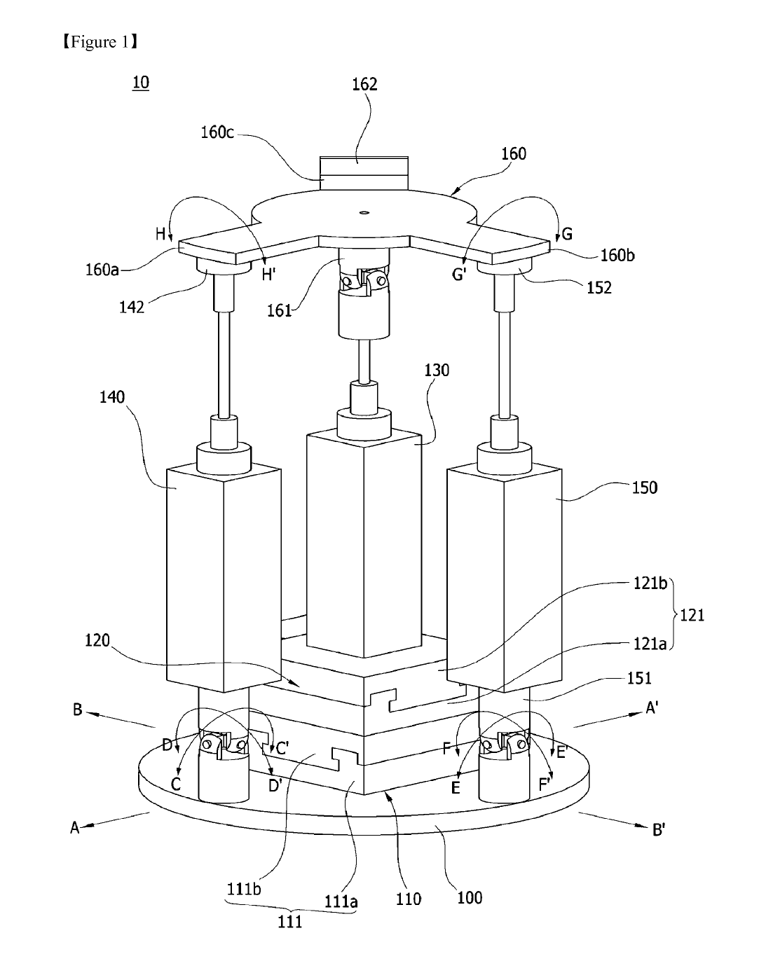

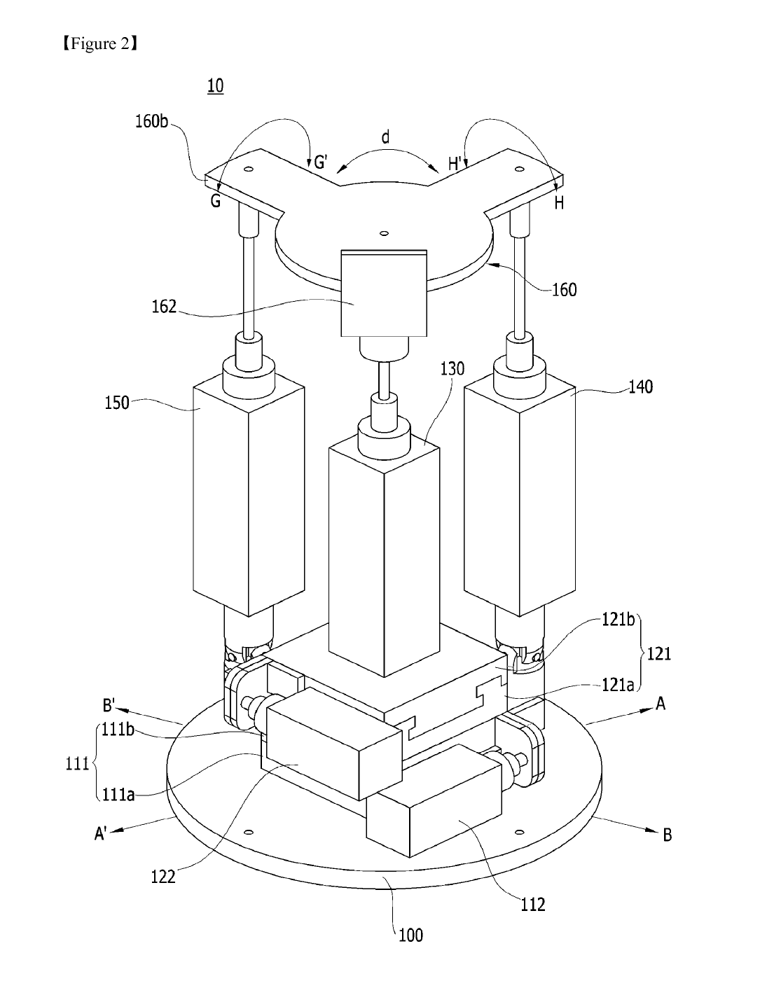

FIG. 1 is a perspective view of a parallel micro-robot with 5 degrees of freedom according to a first embodiment of the present invention, and FIG. 2 is another perspective view of a parallel micro-robot with 5 degrees of freedom according to a first embodiment of the present invention.

Referring to FIGS. 1-2, according to a first embodiment of the present invention, a parallel micro-robot with 5 degrees of freedom includes a base plate 100, a first slide moving unit 110, a second slide moving unit 120, an up/down moving actuator 130, a first angle adjusting actuator 140, a second angle adjusting actuator 150, and an operating plate 160.

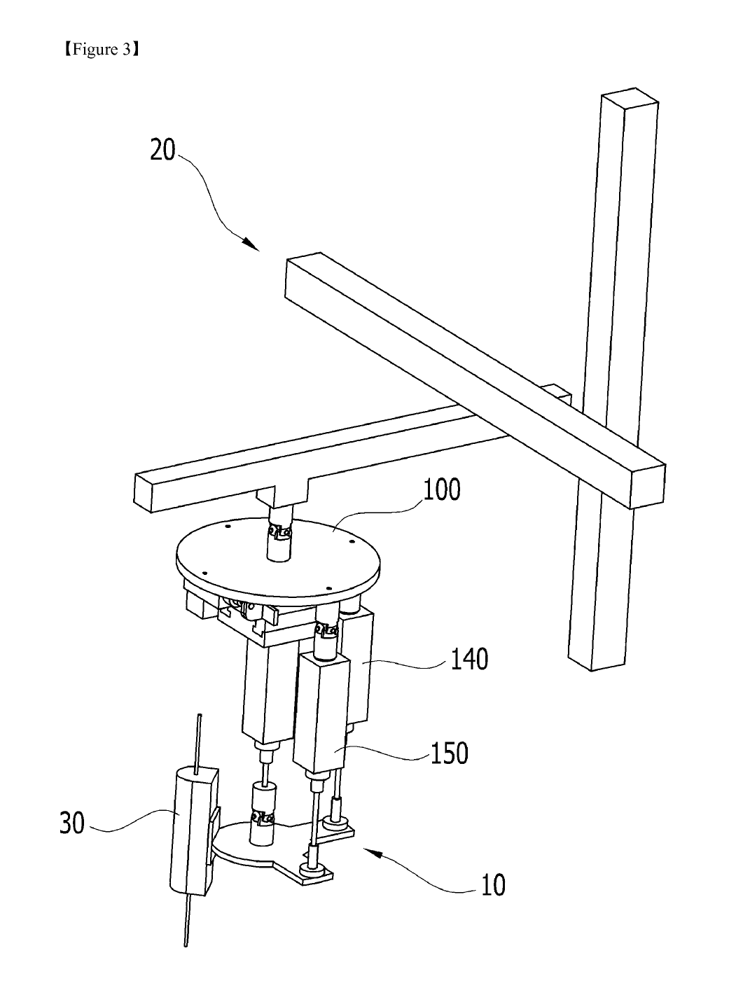

The base plate 100 is rotatably coupled to a macro-robot (20: Referring to FIG. 3). For example, the base plate 100 may be formed in a circular form and rotatably coupled to the macro-robot 20.

The first slide moving unit 110 is installed on the base plate 100. For example, the first slide moving unit 110 includes a LM guide 111 and an actuator 112. A guide part 111a of the LM guide 111 is installed on the base plate 100, and a guide block 111b is inserted into and coupled to the guide part 111a. The actuator 112 is coupled to the guide block 111b such that the guide block 111b is slidingly moved according to the guide part 111a. For example, the actuator may be a cylinder. For example, a cylinder used for the actuator is installed on the guide part 111a to connect the guide block 111b and the load part such that the guide block 111b is moved slidingly by the load part according to the guide part 111a.

The second slide moving unit 120 is installed on the first slide moving unit 110 to move in a different direction from the first slide moving unit 110. For example, it is preferable that it is installed on the first slide moving unit such that the second slide moving unit moves slidingly perpendicular to the first slide moving unit 110. For example, such a second slide moving unit 120 includes a LM guide 121 and an actuator 122. The LM guide 121 is installed on guide part 111a of the first slide moving unit 110, and a guide block 121b is slidingly coupled to the guide block 121a. The actuator 122 is coupled to the guide block 121b such that the guide block is slidingly moved according to the guide part 121a. For example, the actuator 122 may be a cylinder. For example, a cylinder used for the actuator 122 is installed on the guide part 121a to connect the guide block 121b and the load part such that the guide block 121b is moved slidingly by the load part according to the guide part 121a.

The up/down moving actuator 130 is fixed and installed on the second slide moving unit 120. For example, the up/down moving actuator 130 is fixed and installed on the guide block 121b of the second slide moving unit 120 by using plurality of fixing means (not shown). For example, the up/down moving actuator 130 may be a cylinder.

The first angle adjusting actuator 140 is arranged and positioned on a direction in which the first slide moving unit 110 moves, and a bottom portion of the first angle adjusting unit 140 is rotatably coupled to the base plate 100. For example, the first angle adjusting actuator 140 may be coupled to the base plate 100 through a two shafts rotating connection means 141. The two shafts rotating connection means couples the first angle adjusting actuator 140 and the base plate 100 such that the two rotation shafts are parallel to the movement direction of the first and second slide moving units 110 and 120, respectively. Therefore, the two shafts rotating connection means 141 is interlocked with the first slide moving unit 110 and rotates the first angle adjusting actuator 140 in a direction C or C′ when the first slide moving unit 110 is moved in a direction A or A′, and is interlocked with the second slide moving unit 120 and rotates the second angle adjusting actuator 140 in a direction D or D′ when the second slide moving unit 110 is moved in a direction B or B′. Herein, the first angle adjusting actuator 140 may be a cylinder. Meanwhile, the two shafts rotation connection means 141 may be a universal joint.

The second angle adjusting actuator 150 is arranged and positioned on direction which the second slide moving unit 150 moves, and a bottom portion of the second angle adjusting unit 150 is rotatably coupled to the base plate. For example, the second angle adjusting actuator 150 may be coupled to the base plate 100 through a two shafts rotating connection means 151. The two shafts rotating connection means 151 couples the base plate 100 and the second angle adjusting actuator 151 such that two rotation shafts are parallel to movement direction of the first and second slide moving units 110 and 120, respectively. Therefore, the two shafts rotating connection means 151 is interlocked with the first slide moving unit 110 and rotates the first angle adjusting actuator 140 in a direction E or E′ when the first slide moving unit 110 is moved in a direction A or A′, and is interlocked with the second slide moving unit 120 and rotates the second angle adjusting actuator 140 in a direction F or F′ when the second slide moving unit 110 is moved in a direction B or B′. Herein, the second angle adjusting actuator 150 may be a cylinder. Meanwhile the two shafts rotating connection means 141 may be a universal joint.

Meanwhile, it is preferable that the first and second angle adjusting actuators 140 and 150 are arranged in a way that an angle between the first and second angle adjusting actuators 140 and 150 and the up/down moving actuator 130 to be perpendicular.

The operating plate 160 is coupled to the up/down moving actuator 130 such that a center portion of the operating part is rotatable. For example, the up/down moving actuator 130 is coupled to a center portion of the operating plate 160 through two shafts rotating connection means 161. Herein, the two shafts rotating connection means 161 couples the up/down height adjusting actuator 130 and the operating plate 160 such that two rotation shafts are parallel to the first and second slide moving units 110 and 120, respectively. Therefore, the operating plate 160 may be rotated to a direction C or C′ based on the two shafts rotating connection means 161 when one end of the operating plated 160 is risen or fallen by the first angle adjusting actuator 140, and the operating plate 160 may be rotated to a direction H or H′ based on the two shafts rotating connection means 161 when one end of the operating plated 160 is risen or fallen by the second angle adjusting actuator 150. For example, such a two shafts rotating connection means 161 may be a universal joint. And, the operating plate 160 may have a circular form. Alternatively, the operating plate 160 may comprise a first and second connecting parts 160a and 160b coupled to one end of the first and second angle adjusting actuators 140 and 150, respectively, and the other end of the first and second connecting parts 160a and 160b are coupled to each other, and an extension part 160c extended and formed on the other end of the first and second connecting parts 160a and 160b. Herein, the first and second connecting parts 160a and 160b are coupled perpendicular to each other, and separated with equidistant intervals to the extension part 160c.

Meanwhile, the first and second angle adjusting actuators 140 and 150 are coupled to the operating plate 160 through omnidirectional rotating means 142 and 152. For example, the through omnidirectional rotating means 142 and 152 may be a ball joint.

Also, a center portion of the end of the operating plate 160 (extension part 160c) may further comprise a fixing part 162. Herein, a needle inserting device 30 may be fixed and installed on the fixing part 162 of the operating plate 160 using plurality of fixing members (not shown).

Referring to FIGS. 1-3, an operation method and an effect of the parallel micro-robot with five degrees of freedom according to an embodiment of the present invention are as below.

FIG. 3 is a micro-robot according to a first embodiment of the present invention installed on a macro-robot.

Referring to FIGS. 1-3, a parallel micro-robot with five degrees of freedom according to an embodiment of the present invention, a base plate 100 is rotatably coupled to a macro robot 200, and is moved closed to a surgery place by the macro-robot 20 as shown in FIG. 3. After, a precise control of position of a needle inserting device 30 is performed by operating parallel micro-robot with five degrees of freedom according to an embodiment of the present invention. Herein, the macro-robot 20 may have six degrees of freedom.

Thus, after moving the parallel micro-robot with five degrees of freedom according to an embodiment of the present invention by the macro-robot 20, the first and second slide moving units 110 and 120 is operated such that position of the needle inserting device 30 is controlled by moving the operating plate in front and back, right and left.

After controlling position of the needle inserting device 30 in front and back, right and left as above, the up/down moving actuator is operated such that a vertical height of the needle inserting device 30 is controlled by rising or falling the operating plate 160 through the up/down moving actuator 130.

After controlling the vertical height of the needle inserting device, the first angle adjusting actuator 140 and the second angle adjusting actuator 150 is operated such that an needle inserting angle of the needle inserting device installed on the operating plate 160 is controlled as the operating plate 160 is revolved around end of the up/down moving actuator 130.

After controlling the needle inserting angle of the needle inserting device 30 as above, a needle of the needle inserting device 30 is inserted into the surgical area by operating the needle inserting device 30.

According to an embodiment of the present invention, a parallel micro-robot with five degrees of freedom 10 may obtain two degrees of freedom by moving the operating plate 160 in front and back, right and left thorough the first and second slide moving units 110 and 120, obtain one degree of freedom by moving vertically the operating plate 160 through the up/down moving actuator 130, obtaining two degrees of freedom by revolving around end of the up/down actuator 130 in different direction from each other, and as a result, obtains five degrees of freedom.

According to an embodiment of the present invention as above, a parallel micro-robot with five degrees of freedom has the advantage of securing high accuracy by controlling precisely an angle of the operating plate 160 around two shafts rotating connecting means 161, wherein the two shafts rotating connecting means 161 couples the operating plate 160 and the up/down height adjusting actuator by using the first and second angle adjusting actuators 140 and 150.

Also, there is an effect to minimize a surgical space and an installation restrictions by manufacturing in lightweight structure of small-scale as it is possible to reduce innovatively number of actuators to be installed to control angle of operating plate 160 compared with conventional parallel micro-robot by forming operating plate 160 with only the first and second angle adjusting actuators 140 and 150 to control an angle.

Meanwhile, a parallel micro-robot with five degrees of freedom according to an embodiment of the present invention, a position of an operating plate 160 is controlled by the first and second slide moving units 110 and 120 and the un/down moving actuator 130, and a direction of the operating plate 160 is controlled by the first and second angle adjusting actuators 140 and 150. In other words, it is possible to control more precisely since mechanical properties are improved by adjusting position of the operating plate using the first and second slide moving units and the up/down moving actuator, and an orientation motion and a translation motion are driven separately as direction of the operating plate is adjusted by the first and second angle adjusting actuators.

### Second Embodiment

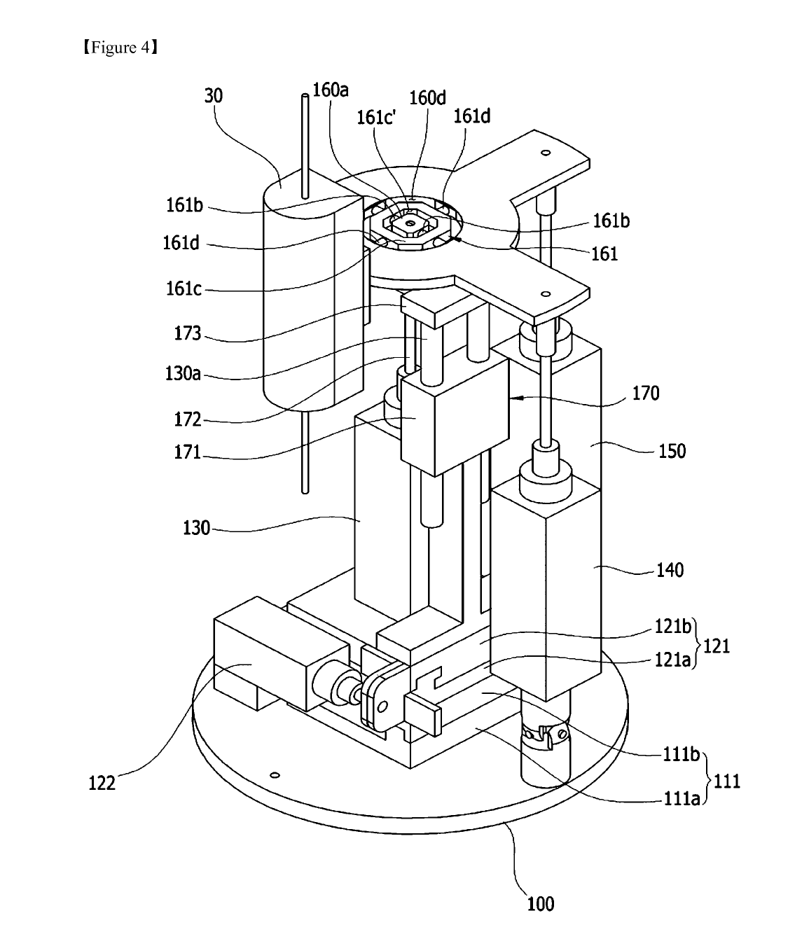

FIG. 4 is a perspective view of a parallel micro-robot with 5 degrees of freedom according to a second embodiment of the present invention.

According to an embodiment of the present invention, a parallel micro-robot with five degrees of freedom is substantially the same as the parallel micro-robot with five degrees of freedom of the first embodiment except for a connection formation of the up/down moving actuator and the addition of a roll motion preventing unit 170, a detailed explanation is skipped except for a connection formation between the base plate 160 and the up/down moving actuator 130 and some of roll motion preventing unit 170, and the same reference numerals are given to the same elements as to the first embodiment.

Referring to FIG. 4, the operating plate 160 may further comprise a connecting hole 160d in a center portion. Meanwhile, the two shafts rotating connection means that is connected to the up/down moving actuator 130 is inserted and coupled to the connecting hole 160d. Therefore, the operating plate 160 is coupled to the up/down moving actuator 130 such that the center portion is rotatable. For example, the two shafts rotating connection means 161 coupled the up/down height adjusting actuator 130 and the operating plate 160 such that the two rotation shafts are parallel to a movement direction of each of the first and second slide moving units 110 and 120. Therefore, the operating plate 160 is rotated to a direction G or G′ based on the two shafts rotating connection means 161 when one end of the operating plated 160 is risen or fallen by the first angle adjusting actuator 140, and the operating plate 160 is rotated to a direction H or H′ based on the two shafts rotating connection means 161 when the other end of the operating plated 160 is risen or fallen by the second angle adjusting actuator 150.

Explaining in more detail the two shafts rotating connection means above, the two shafts rotating connection means 161 includes a fixing plate 161, a pair of first rotation shafts 161b, a rotating plate 161c, and a pair of second rotation shafts 161d.

The fixing part 161a is installed on the up/down moving actuator 130 such that it is inserted into a hole 160d of the operating plate 160.

The pair of first rotation shafts 161b are installed on the first fixing plate 161a. For example, the pair of first rotation shafts 161a are installed on the fixing plate 161a such that they are arranged to be parallel to a movement direction of the first slide moving unit 110 or the second slide moving unit 120. Meanwhile, the pair of first rotation shafts 161b are installed on the fixing part 161a to be placed on a same line.

A through hole 161c′ is formed on a center portion of the rotation plate 161c, and the fixing plate 161a is disposed on the inside of the through hole 161c′ and makes the first coupled of rotation shaft 161b to be rotated.

An end portion of the second pair of rotation shafts 161d are fixed to the operating plate 160, and another end portion are rotatably coupled to the rotation plate 161c. For example, the pair of second the rotation shafts 161d are rotatably coupled to the operating plate 160 such that they are arranged to be parallel to a movement direction of the first slide moving unit 110 or the second slide moving unit 120. In other words, they are arranged perpendicular to the first couple of rotation shaft 161a, so that the rotation plate 161c is rotatably coupled to the operating plate 160. Meanwhile, the pair of second rotation shafts 161d are also arranged to be positioned on the same line like the pair of first rotation shafts 161a so that the rotation plate 161c is rotatably coupled to the operating plate 160.

The parallel micro-robot with five degrees of freedom according to the second embodiment of the present invention as above, the pair of first rotation shafts are fixed to a fixing plate 161a which is coupled to the up/down moving actuator 130, and the pair of second rotation shafts are fixed to the operating plate 160, and even though the operating plate 160 is rotated on the two shafts rotating connection means 151 by operating the first and second slide moving unit 110 and 120 or the first and second angle adjusting actuator 140 and 150, there is no gap in the two shafts rotating connection means 161, and therefore it is possible to control more precisely.

Also, according to the second embodiment of the present invention as above, a parallel micro-robot with five degrees of freedom may further include a roll motion preventing unit 170.

The roll motion preventing unit 170 is fixed and installed on the up/down moving actuator 130 to couple the up/down moving actuator 130 and a load 130a, and supports a load 130a of the up/down moving actuator 130.

The roll motion preventing unit 170 includes a supporting member 17, at least one guide member, and a connecting block 173.

The supporting member 171 is fixed and installed on the second slide moving unit 120.

The at least one guide member 172 is slidingly coupled to the supporting member 171. Herein, in order to support the connecting block 172 more stable, it is preferable to couple slidingly at least a couple of guide members.

The connecting block 173 is installed on the guide member 172, fixed and coupled to the load 130a of the up/down moving actuator 130 to prevent rolling phenomenon of the load 130a of the up/down moving actuator 130 by supporting the load 130a.

The roll motion preventing unit 170 as above, when the load 130a of the up/down moving actuator 130 is risen, then the connecting block 173 which is fixed and coupled to the load 130a is also risen as it is interlocked with the load, and since the connecting block 173 is risen, the guide member 172 is also risen as it is interlocked with the connecting block 173.

A parallel micro-robot with five degrees of freedom according to the second embodiment of the present invention as above, even though the operating plate 160 is rotated to the first and second slide moving units 110 and 120 or the first and second angle adjusting actuators 140 and 150 by supporting the load 130a of the up/down moving actuator 130 which is connected to the operating plate 160, a rolling phenomenon of the load 130a of the up/down moving actuator 130 is prevented such that it is possible to control more precisely.

The roll motion preventing unit 170 may be applied to parallel micro-robot with five degrees of freedom of the first embodiment of the present invention even though the roll motion preventing unit 170 of figure is applied only to parallel micro-robot with five degrees of freedom of the second embodiment of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

<Code description>

| | |
|---|---|
| 100: base plate | 110: first slide moving unit |
| 120: second slide moving unit | 130: up/down moving actuator |
| 140: first angle adjusting actuator | 150: second angle adjusting actuator |
| 160: operating plate | 170: roll motion preventing unit |

1. A parallel micro-robot with five degrees of freedom comprising:
a first slide moving unit installed on a base plate;
a second slide moving unit installed on the first slide moving unit such that the second slide moving unit slidingly moves in a different direction from the first slide moving unit;
an up/down moving actuator fixed and installed on the second slide moving unit;
a first angle adjusting unit arranged to be positioned on a movement direction of the first slide moving unit, the bottom portion of the first angle adjusting unit being rotatably coupled to the first base plate is rotated;
a second angle adjusting unit arranged to be positioned on a movement direction of the second slide moving unit, the bottom portion of the second angle adjusting unit being rotatably coupled to the first base plate is rotated; and
an operating plate, wherein a center portion of the operating plate is rotatably coupled to the up/down moving actuator, and both sides of an end portion of the operating plate are rotatably coupled to the first and second angle adjusting actuators.

2. The parallel micro-robot with five degrees of freedom of claim 1, wherein the second slide moving unit is installed on the first slide moving unit such that the second slide moving unit moves in a vertical direction to the first slide moving unit.

3. The parallel micro-robot with five degrees of freedom of claim 1, wherein the first and second angle adjusting actuators are arranged perpendicular to the up/down moving actuator.

4. The parallel micro-robot with five degrees of freedom of claim 1, wherein the height adjusting actuator is connected to the center portion of the operating plate through two shafts rotating connection means.

5. The parallel micro-robot with five degrees of freedom of claim 4, wherein the two shafts rotating connection means couples the height adjusting actuator and the operating plate such that two rotation shafts are arranged parallel to a movement directions of the first and second slide moving units, respectively.

6. The parallel micro-robot with five degrees of freedom of claim 1, wherein the first and second angle adjusting actuators are connected to the base plate through a two shafts rotating connection means.

7. The parallel micro-robot with five degrees of freedom of claim 6, wherein the two shafts rotating connection means couples the first and second angle adjusting actuators and the base plate such that the two rotation shafts are arranged parallel to the movement directions of the first and second slide moving units, respectively.

8. The parallel micro-robot with five degrees of freedom of claim 4, wherein the two shafts rotating connection means is a universal joint.

9. The parallel micro-robot with five degrees of freedom of claim 1, wherein the first and second angle adjusting actuators are coupled to the operating plate through an omnidirectional rotation means.

10. The parallel micro-robot with five degrees of freedom of claim 9, wherein the omnidirectional rotation means is a ball joint.

11. The parallel micro-robot with five degrees of freedom of claim 1, wherein each of the first and second slide moving unit is a LM guide.

12. The parallel micro-robot with five degrees of freedom of claim 4, wherein the two shafts rotating connection means comprises:
a fixing plate installed on the up/down moving actuator to be inserted into a hole formed on the operating plate;
a pair of first rotation shafts arranged parallel to the movement direction of the first slide moving unit or the movement of the second slide moving unit, and installed on the fixing plate to be positioned on a same line;
a rotating plate forming a through hole to insert the fixing plate and rotatably coupled to the pair of first rotation shaft; and
a pair of second rotation shafts rotatably coupling the rotation plate to the operating plate such that the pair of second rotation shafts are arranged parallel to the second slide moving unit or the movement direction of the second slide moving unit, and are disposed to be positioned on a same line.

13. The parallel micro-robot with five degrees of freedom of claim 1, further comprising a roll motion preventing unit fixed and installed on the second slide moving unit to be coupled to the up/down moving actuator.

14. The parallel micro-robot with five degrees of freedom of claim 13, wherein the roll motion preventing unit comprises a supporting member fixed and installed on the second slide moving unit, at least one guide member slidingly coupled to the supporting member, and a connecting block installed on the guide member to be fixed and coupled to the up/down moving actuator.

15. The parallel micro-robot with five degrees of freedom of claim 6, wherein the two shafts rotating connection means is a universal joint.
